(19) United States
(12) Patent Application Publication
(10) Pub. No.: US 2009/0038456 A1
(43) Pub. Date: Feb. 12, 2009

(54) Cut Finish Actuator For Table Saw

(76) Inventors: Wade Burch, Wauwatosa, WI (US); William C. Buck, Clemson, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/171,752

(22) Filed: Jul. 11, 2008

Related U.S. Application Data
(60) Provisional application No. 60/951,330, filed on Jul. 23, 2007.

(51) Int. Cl. B26D 5/38

(52) U.S. Cl. 83/372

(57) ABSTRACT

A table saw having an actuator to stop rotation of the cutting blade when the cutting operation for the material being cut is complete. The actuator is located adjacent the cutting blade near the midpoint of the opening through which the cutting blade extends.

This application claims priority to U.S. Provisional Application Ser. No. 60/951,330 filed Jul. 23, 2007, the entire contents of which are incorporated herein by reference.

The present invention relates to an actuator for a table saw that stops rotation of the cutting blade and in particular to an actuator that stops rotation of the cutting blade when the cuffing operation for material that is being cut is finished. The invention is suitable for all manner of cutting operations including through cuts and non-through cuts.

### SUMMARY

The present invention provides a table saw with a top surface having an opening through which a cutting blade extends. The opening has a longitudinal length greater than the diameter of the cutting blade to provide clearance for the cutting blade. The table saw also has an actuator located adjacent at least one side of the opening near the midpoint of the longitudinal length of the opening. The actuator functions to stop rotation of the blade when actuated. The actuator will be actuated when the desired cuffing operation for the material being cut is complete. It will be appreciated that by locating the actuator near the midpoint of the longitudinal length of the opening, the cutting operation for the material being cut will have been completed at that time. The rotation of the blade may occur by stopping power to the motor which drives the blade, by providing a clutch operatively associated with the motor and blade such that the clutch will allow the motor to run yet prevent the blade from rotating, by providing a brake to stop rotation of the blade, combinations of the above and other known structures for stopping the rotation of the blade.

In one aspect, the actuator includes a biased switch that can be depressed when the material that is being cut comes into contact with the switch. Depression of the switch will initialize a circuit so that when there is no material operating against the bias of the switch, the switch will be biased away from the surface of the table saw and stop rotation of the cutting blade. In this aspect, it will be understood that the switch is normally biased away from the top surface of the table saw. The actuator may include a laser, an infra-red source, a photocell, or other type of switch such that when the switch is actuated the cutting blade is stopped from rotation.

### BRIEF DESCRIPTION OF THE DRAWINGS

FIG. 1 shows a perspective view of a representative table saw incorporating the cut finish actuator of the present invention.

FIG. 2 is a side of the table saw of FIG. 1 with a portion of the side being cut away to illustrate the motor.

FIG. 3 is a top view of the table saw of FIG. 1 with the blade removed to better illustrate certain concepts of the invention.

FIGS. 4-6 show operation of one embodiment of the actuator of the present invention with the blade removed to better illustrate the operation. In particular, FIG. 4 shows the actuator as the material is initially being cut but before it is in contact with the actuator. In this aspect, the actuator is in its normally biased position with the switch located away from the top surface of the table.

FIG. 5 shows the actuator as the material is being cut and with the switch in a depressed position.

FIG. 6 shows the actuator when the cutting operation for the material is completed and the actuator is biased away from the top surface of the table.

### DETAILED DESCRIPTION

The invention is described with reference to the drawings in which like elements are referred to by like numerals. The relationship and functioning of the various elements of this invention are better understood by the following description. Each aspect so defined may be combined with any other aspect or aspects unless clearly indicated to the contrary. The embodiments described below are by way of example only, and the invention is not limited to the embodiments illustrated in the drawings.

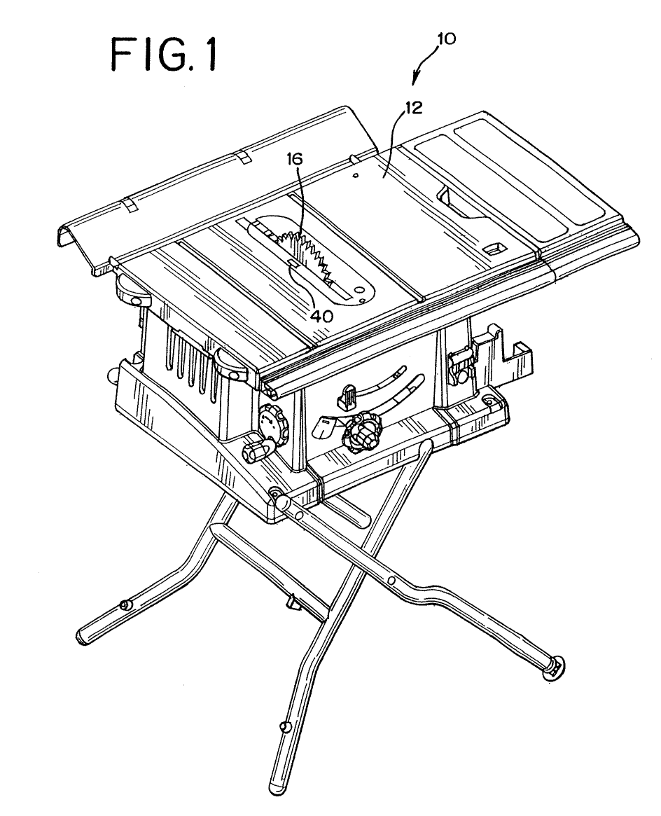

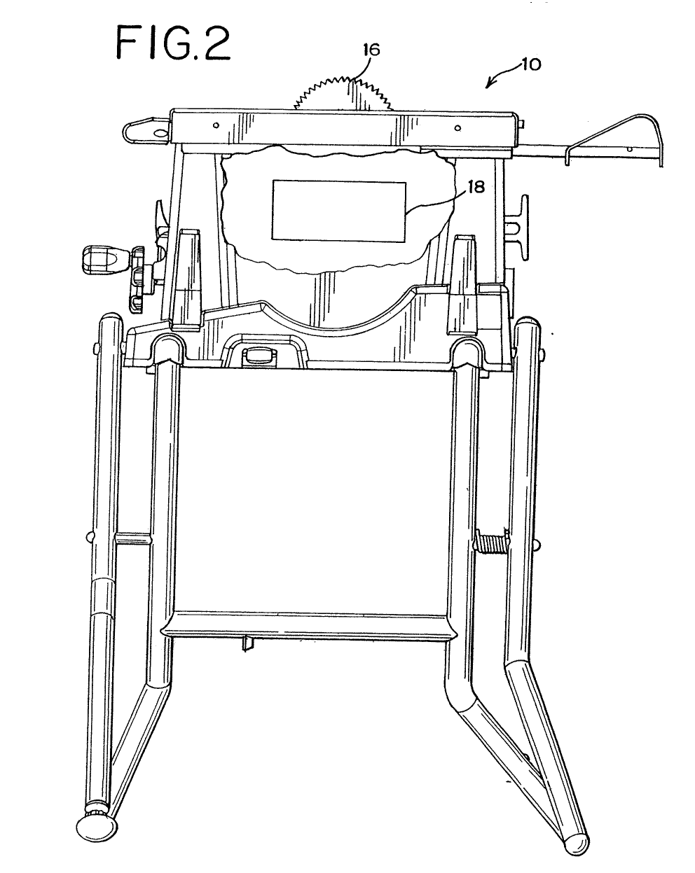

Turning now to FIG. 1, a table saw 10 having the cut finish actuator of the present invention is shown. The table saw 10 can be of any known type such as a stand-alone table saw or a portable table saw. The table saw shown in FIG. 1 is designed to be moved. The table saw 10 includes a top or cutting surface 12. The top or cuffing surface 12 includes an opening 30 through which a blade 16 extends. In general, as better seen in FIG. 2, the blade is rotated by a motor 18 located below the top surface 12. The blade 16 is used to cut material 20 such as wood that is pushed along the top or cutting surface 12 and moved into contact with the blade 16.

The opening 30 has a first side 32 and a second side 34 to define a width W and a first end 36 and a second end 38 to define a longitudinal length L. The first end 36 is associated with the beginning of the material 20 to be cut. In other words, the saw blade 16 rotates in a direction toward the first end 36 of the opening 30.

At least one actuator 40 is located adjacent the opening 30 at or near the mid point of the longitudinal length L of the opening 30. It is contemplated to provide an actuator 40 adjacent at least one side of the opening 30 near the mid point of the longitudinal length L of the opening 30. In one aspect, the at least one actuator 40 is located within about 10% of the distance from the midpoint of the longitudinal length L. For example, if the longitudinal length is 20 mm, the midpoint would be 10 mm and the actuator could be located within about 9 to about 11 mm from the first end 36 of the opening 30. In another aspect, the actuator 40 is provided at the mid point of the longitudinal length. Desirably, the actuator is provided after the mid point. The term “after” means that the actuator is closer to the second end 38 of the opening than the first end 36 of the opening.

The actuator 40 functions to stop rotation of the blade 16 when actuated. The actuator 40 will be actuated when the cutting operation for the material 20 being cut is complete. It will be appreciated that by locating the actuator 40 near the midpoint of the longitudinal length L of the opening 30, the cutting operation for the material 20 being cut will have been completed.

The rotation of the blade 16 may occur by stopping power to the motor 18 which drives the blade 16 or by providing a clutch operatively associated with the motor 18 and blade 16 such that the clutch will allow the motor 18 to run yet prevent the blade 16 from rotating. The rotation of the blade 16 may also occur by providing a brake to physically stop rotation of the blade 16. Of course, it is contemplated that each of the above structures for stopping rotation of the blade 16 may be used in combination with each other.

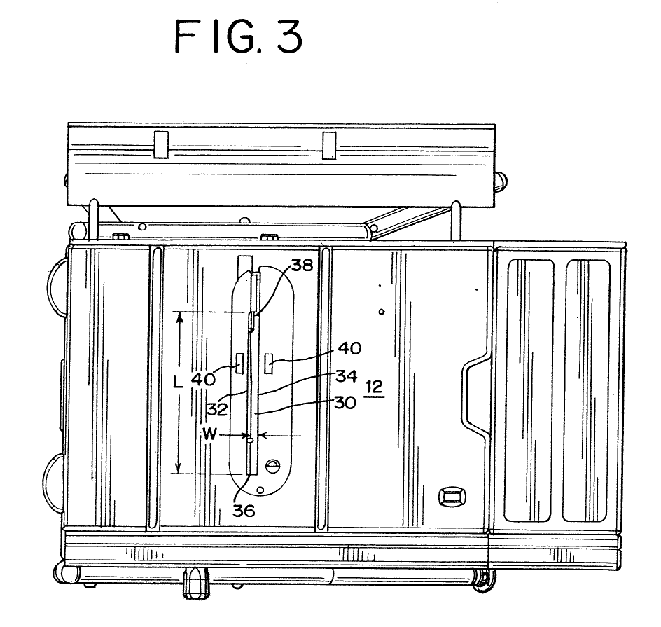

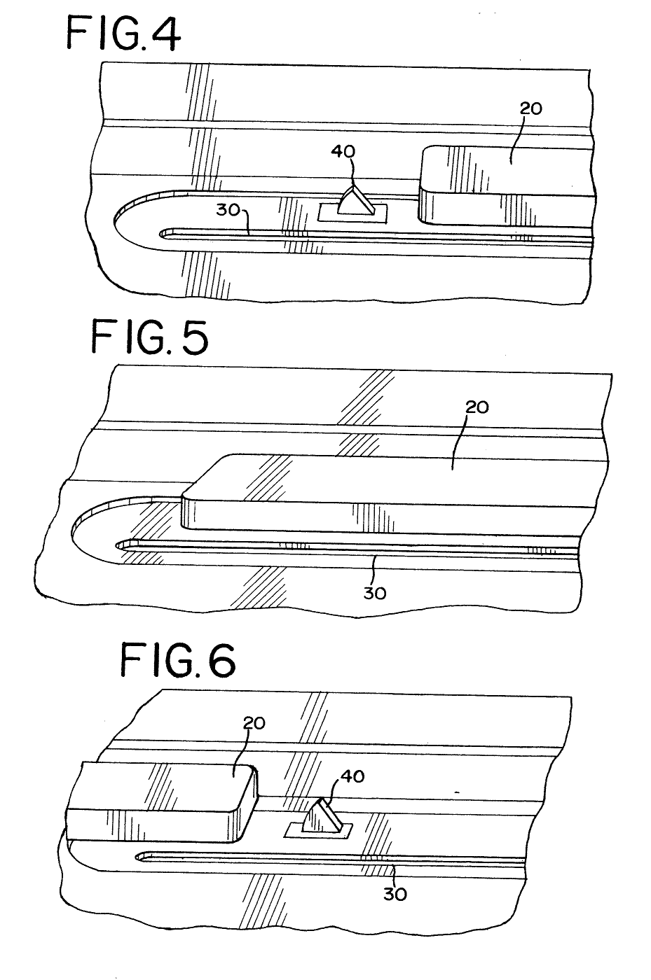

In one aspect, the actuator 40 includes a biased switch that can be actuated in the following manner. As seen in FIG. 4, the switch is normally biased in a position such that it extends from the top surface 12 of the table saw 10. As the cutting of the material 20 begins, the switch is depressed to initialize the switch as shown in FIG. 5. Subsequently, as the cutting operation is completed and the material moves past the switch, the switch is again biased away from the top surface as shown in FIG. 6, causing the rotation of the blade to stop. One of skill in the art can appreciate that the actuator 40 described above will operate during a variety of cutting operations such as a through cut, a non-through cut, and the actuator 40 and its operation are not limited by the type of cut being performed.

While FIGS. 4-6 shown one form of an actuator 40, it is contemplated that the actuator may include a laser, an infra-red source, a photocell, or other type of switch such that when the cutting operation for the material being cut is completed, the switch is actuated causing the cutting blade to stop rotating.

The foregoing detailed description has described only a few of the many forms that this invention can take. For this reason, this detailed description is intended by way of illustration, and not by way of limitation. It is only the following claims, including all equivalents that are intended to define the scope of this invention.

1. A table saw comprising:
a. a top surface with an opening having a first end and a second end to define a longitudinal length and through which a rotatable blade extends;
b. an actuator located adjacent the opening near a midpoint of the longitudinal length of the opening and operable to stop rotation of the rotatable blade.

2. The table saw of claim 1 further comprising a motor to drive the rotatable blade.

3. The table saw of claim 2 wherein the actuator when actuated stops power to the motor.

4. The table saw of claim 1 wherein the actuator is actuated when a cutting operation for a material being cut by the rotatable blade is complete.

5. The table saw of claim 1 wherein the actuator is located closer to the second end of the opening than the first end.
